(19) United States
(12) Patent Application Publication
(10) Pub. No.: US 2005/0287350 A1
(43) Pub. Date: Dec. 29, 2005

(54) Encapsulating compound having reduced dielectric constant

(76) Inventors: David L. Crouthamel, Bethlehem, PA (US); Jeffery J. Gilbert, Schwenksville, PA (US); John W. Osenbach, Kutztown, PA (US)

Correspondence Address: Ryan, Mason & Lewis, LLP, 90 Forest Avenue, Locust Valley, NY, 11560, US

(21) Appl. No.: 10/878,830

(22) Filed: Jun. 28, 2004

(51) Int. Cl. B32B 3/26

(52) U.S. Cl. 428/321.1

(57) ABSTRACT

An encapsulating compound includes an organic polymeric carrier material and a dielectric filler material added to the polymeric carrier material. The dielectric filler material has a dielectric constant associated therewith which is less than a dielectric constant of the polymeric carrier material. The dielectric filler material is interspersed with the polymeric carrier material such that a dielectric constant of the encapsulating compound is less than the dielectric constant of the polymeric carrier material alone.

### FIELD OF THE INVENTION

The present invention relates generally to electronic device encapsulation, and more particularly relates to an encapsulating compound having a reduced dielectric constant which may be used in encapsulating electronic devices.

### BACKGROUND OF THE INVENTION

Electronic devices, such as, for example, power transistors, are often employed for use in applications requiring high power (e.g., several watts or more) and/or high frequency (e.g., greater than about one megahertz (MHz)) operation. It is well known to package such electronic devices in ceramic packages, which typically offer superior high-frequency and high-power performance compared to plastic packages. However, the cost of ceramic packages is significantly higher than the cost of plastic packages, and therefore it would be desirable to migrate to plastic packages.

In general, plastic packages, unlike ceramic packages, are not hermetic. As such, there is a need to protect all metal-bearing parts of the package assembly from humidity and environmental contaminants so as to prevent electrical degradation of the device via electrochemical corrosion, among other degradation mechanisms. This is typically accomplished by encapsulating the device with an organic encapsulating compound such as, for example, silicone gel, epoxy, etc. Unfortunately, because the encapsulating compounds have dielectric constants that are significantly high (e.g., greater than about 2.8 for silicone gel) compared to air, which has a dielectric constant of 1.0, coating the device with the encapsulating compound degrades the performance of the device.

For instance, because traditional encapsulating compounds (e.g., silicone gel, epoxies, etc.) have dielectric constants that are significantly high (e.g., greater than about 2.8 for silicone gel or greater than about 3.9 for epoxies) compared to air, which has a dielectric constant of 1.0, coating an IC device with the encapsulating compound degrades the performance of the device. Devices that are coated with conventional encapsulating compounds typically exhibit frequency and/or gain attenuation which is directly attributable to the increased dielectric constant of the encapsulating compounds. The degradation in performance is even more pronounced as power and/or frequency requirements of the device become more stringent. Moreover, this degradation in performance is not confined to devices, but may also affect, for example, other circuits, conductive traces (e.g., connectors), etc., to which such organic encapsulating compounds are applied.

There exists a need, therefore, for an encapsulating compound capable of improved performance and reliability that does not suffer from one or more of the above-noted deficiencies typically affecting conventional encapsulating compounds.

### SUMMARY OF THE INVENTION

The present invention provides techniques for forming an encapsulating compound having a reduced dielectric constant, and thereby exhibiting improved high-frequency and/or high-power performance compared to conventional encapsulating compounds.

In accordance with one aspect of the invention, an encapsulating compound includes an organic polymeric carrier material and a dielectric filler material added to the polymeric carrier material. The dielectric filler material has a dielectric constant associated therewith which is less than a dielectric constant of the polymeric carrier material. The dielectric filler material is interspersed with the polymeric carrier material such that a dielectric constant of the encapsulating compound is less than the dielectric constant of the polymeric carrier material alone. A reduction in the dielectric constant of the encapsulating compound may be related to a weight percentage of the dielectric filler material in the polymeric carrier material.

In an illustrative embodiment of the invention, the organic polymeric carrier material comprises silicone gel, epoxies and/or molding compounds. The dielectric filler material comprises polytetrafluoroethylene (PTFE or Teflon®, a registered trademark of DuPont Company), ethylene tetrafluoroethylene (ETFE), ethylene chlorotrifluoroethylene (ECTFE), perfluoroalkoxy (PFA), nylon, nylon 6, nylon 66, polymer, thermoplastic and/or fluoropolmer. Other possible filler materials may include, for example, hollow spheres or hollow rods of silicon dioxide (SiO₂). Preferably, the encapsulating compound comprises silicone gel, as a polymeric carrier material, doped with about eighty percent by weight of PTFE spheres, as a dielectric filler material.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 is a cross-sectional view depicting at least a portion of an encapsulating compound, formed in accordance with one embodiment of the present invention.

FIG. 2 is a cross-sectional view of at least a portion of an encapsulating compound comprising a dielectric filler material having an increased packing density compared to the encapsulating compound shown in FIG. 1, in accordance with another embodiment of the invention.

FIG. 3 is a cross-sectional view depicting an encapsulating compound comprising a multi-modal dielectric filler material, formed in accordance with yet another embodiment of the invention.

FIGS. 4A and 4B illustrate a side view and a perspective partial cut-away view, respectively, of a packaged integrated circuit device comprising an encapsulating compound formed in accordance with the techniques of the present invention.

FIG. 5 is a perspective partial cut-away view depicting an open-cavity integrated circuit package in which the techniques of the present invention may be employed.

### DETAILED DESCRIPTION

The present invention will be described herein in the context of an illustrative encapsulating compound that exhibits a lower dielectric constant compared to traditional encapsulating compounds. The term “encapsulating compound” as used herein is intended to include potting compounds and/or other materials which may be used to encapsulate a device. The term “device” as used herein is intended to include circuits, components, printed circuit boards, connections, traces, connectors, connector pins, etc. While the techniques of the present invention may be advantageously employed, for example, to form plastic integrated circuit (IC) packages, the invention is not limited exclusively to an IC packaging application. Rather, the techniques of the invention may be beneficially used for coating any devices, or other structures, in which considerations of electrical performance, especially frequency and/or gain attenuation, are important.

As previously stated, ceramic IC packages are typically hermetically sealed from environmental contaminants and moisture, and therefore do not require encapsulating the device contained therein with an organic encapsulating compound. However, ceramic IC packages are significantly more expensive to manufacture, compared to plastic IC packages, and are thus undesirable. Although plastic IC packages offer a more cost-effective alternative to ceramic packages, certain properties of traditional encapsulating compounds used in the manufacture of the plastic packages, such as, for example, dielectric constant, can undesirably affect the overall electrical performance of the device.

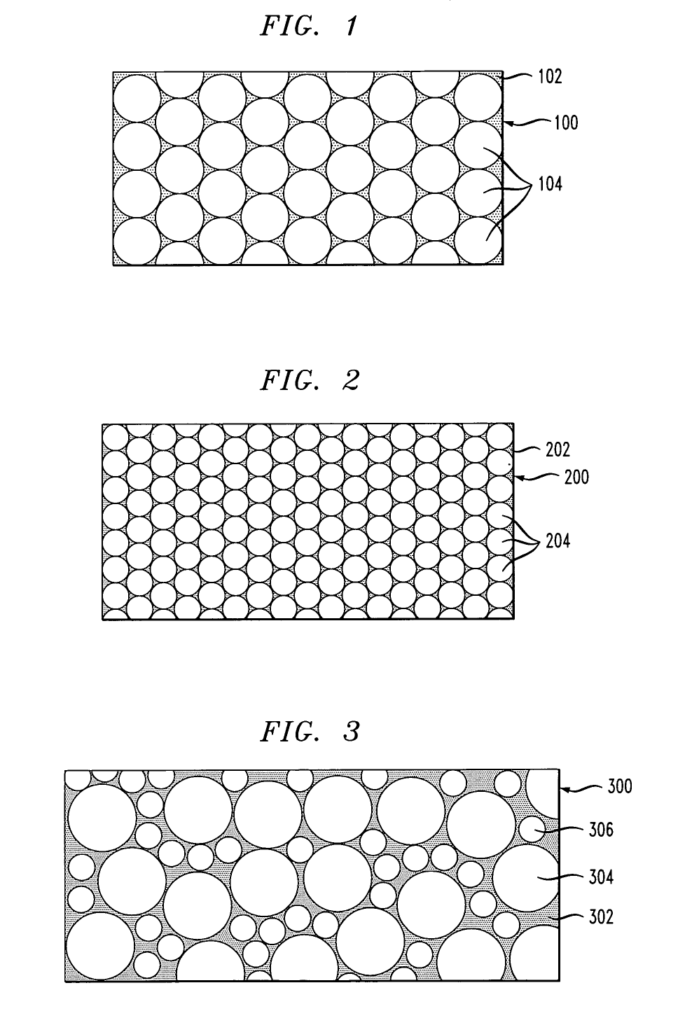

FIG. 1 illustrates a cross-sectional view of at least a portion of an exemplary encapsulating compound 100 formed in accordance with one embodiment of the invention. The encapsulating compound 100 comprises an organic polymeric carrier material 102, such as, but not limited to, silicone gel, epoxies, molding compounds, etc. The encapsulating compound 100 further comprises a dielectric filler material 104, such as, for example, polytetrafluoroethylene (PTFE or Teflon®, a registered trademark of DuPont Company), added to the polymeric carrier material 102, although alternative low dielectric constant filler materials may also be employed, including, but not limited to, ethylene tetrafluoroethylene (ETFE), ethylene chlorotrifluoroethylene (ECTFE), perfluoroalkoxy (PFA), nylon, nylon 6, nylon 66, polymer, thermoplastic, fluoropolmer, etc. A ratio of the filler material 104 to the carrier material 102 is preferably controlled so as to selectively optimize a performance of the encapsulated device as desired.

The dielectric filler material 104 is preferably interspersed with the carrier material 102 so that the dielectric constant of the encapsulating compound 100 is less than the dielectric constant of the carrier material alone. In a preferred embodiment of the invention, the dielectric filler material 104 is preferably interspersed with the carrier material 102 encapsulating compound as to distribute the filler material substantially uniformly within the carrier material. In this manner, the dielectric constant of the encapsulating compound will be substantially uniform throughout. The present invention also contemplates that the filler material 104 may be selectively interspersed (e.g., non-uniformly) with the carrier material 102, so as to vary the dielectric constant throughout the encapsulating compound 100 as desired. This may be beneficial, for example, for impedance matching applications.

In accordance with one aspect of the present invention, in order to advantageously reduce the dielectric constant of the encapsulating compound 100, the dielectric filler material 104 has a dielectric constant ε₁ associated therewith which is lower than a dielectric constant ε₂ of the polymeric carrier material 102. The dielectric constant ε_{C} of the resulting encapsulating compound 100 can be determined, at least to a first order approximation, by the expression
ε_{C}≈wt₁%·ε₁+wt₂%·ε₂,
where wt₁ % is the weight percentage of the dielectric filler material 104 and wt₂ % is the weight percentage of the polymeric carrier material 102 in the encapsulating compound 100. The amount and/or type of filler material used in the encapsulating compound may be determined, at least in part, by balancing the dielectric constant requirements of the electrical circuit to be encapsulated with other characteristics of the encapsulating compound, including, for example, required adhesion and encapsulant flow properties. The percentage of filler material in the encapsulating compound may vary, for example, from about one percent to about 95 percent, depending on the required characteristics of the resulting encapsulating compound.

By way of example only, and without loss of generality, in an illustrative embodiment of the invention, the carrier material 102 comprises silicone gel having a dielectric constant of about 3.1 and the filler material 104 comprises PTFE spheres having a dielectric constant of about 1.9. Doping the silicone gel with about eighty percent by weight of PTFE would result in an encapsulating compound 100 having a dielectric constant of about 2.1, which is substantially lower than the dielectric constant of the carrier material alone. In addition, because PTFE is hydrophobic, as is the silicone gel, the dielectric properties of the resulting two-phase encapsulating compound would be substantially unaffected by extended environmental exposure (e.g., exposure to moisture and/or heat).

Since it is desirable to reduce the dielectric constant of the encapsulating compound as much as possible, it is preferable to utilize as high a proportion of the dielectric filler material 104 in the encapsulating compound as is possible. However, at some point there are certain practical considerations which may limit the proportion of filler material 104 that can be added to the carrier material 102. For example, such characteristics as wetting behavior, packing density of the filler material, etc., can affect the weight percentage of the filler material which can be added to the carrier material in forming the encapsulating compound 100. Moreover, depending on the respective types of materials selected for the carrier material 102 and the filler material 104, the proportion of filler material in the encapsulating compound 100 can affect the structural integrity of the compound, particularly at high temperatures (e.g., above about 200 degrees Celsius).

As apparent from FIG. 1, the filler material 104 preferably comprises a plurality of particles (e.g., spheres, rods, etc.) of a predetermined size, such as, for example, less than about 25 micrometers (μm) for fine pitch (e.g., less than about 80 μm) wire spacing. The size of the particles in the filler material 104 will generally affect a packing density of the filler material. As the particle size of the filler material decreases, the packing density of the filler material will increase accordingly, at least until a finite limitation is reached (e.g., an atomic or molecular limit of the material). The dielectric constant of the encapsulating material may therefore be controlled, at least in part, by varying a particle size of the dielectric filler material. It is to be appreciated that although the filler material is shown as comprising spherically shaped particles, the invention is not limited to the size and/or shape of the particles. Moreover, the particles may be nonuniform and/or arbitrarily shaped.

FIG. 2 is a cross-sectional view depicting at least a portion of an exemplary encapsulating compound 200, formed in accordance with another embodiment of the invention. Like the encapsulating compound 100 shown in FIG. 1, the encapsulating compound 200 comprises a polymeric carrier material 202 to which a dielectric filler material 204 is added. As apparent from the figure, the filler material 204 comprises a plurality of particles. In comparison to the filler material 104 in the compound 100 of FIG. 1, particles forming the filler material 204 are substantially smaller in size. For dimensions used in present state-of-the-art packaging methodologies, this essentially translates to higher fill. Consequently, the packing density of the filler material 204 is greater compared to filler material 104. Since the packing density of the filler material 204 is greater, the proportion of filler material 204 which can be added to the carrier material 202 in forming encapsulating compound 200 will also be higher, thus yielding an encapsulating compound 200 having a lower dielectric constant compared to the encapsulating compound 100 of FIG. 1.

While the exemplary encapsulating compounds 100 and 200 depicted in FIGS. 1 and 2, respectively, each comprise a dielectric filler material having substantially uniformly sized particles, FIG. 3 illustrates an encapsulating compound 300 comprising a multimodal dielectric filler material 304 added to a polymeric carrier material 302, in accordance with another aspect of the invention. Specifically, as apparent from the figure, the filler material may be comprised of two or more different size particles 304 and 306 to further increase the packing density of the filler material in the encapsulating compound 300. The different size particles 304, 306 of the filler material may each comprise a different dielectric material (e.g., PTFE and polystyrene, respectively). Alternatively, the particles 304, 306 may represent different sizes of the same type of filler material. Furthermore, as previously explained, although the filler material is shown as comprising spherically shaped particles, the invention is not limited to the size and/or shape of the particles. In either case, the dielectric filler material added to the carrier material 302 is selected so as to have a lower dielectric constant compared to the dielectric constant of the carrier material 302, thereby reducing the dielectric constant of the encapsulating compound 300 compared to the dielectric constant of the carrier material alone.

The present invention contemplates that the filler material added to the carrier material in forming the encapsulating compound may comprise air, which has one of the lowest dielectric constants (e.g., 1.0) of any of the dielectric materials. This may be accomplished, for example, by aerating the carrier material prior to thermosetting, while the carrier material is still in a substantially liquid (e.g., molten) form, so as to form air bubbles interspersed throughout the carrier material. However, while using air as the filler material may yield an encapsulating compound having an even lower dielectric constant, in comparison to other types of filler materials (e.g., PTFE), a structural rigidity of the encapsulating compound may not be sufficient to meet certain design criteria, particularly at elevated temperatures (e.g., above about 200 degrees Celsius). For applications in which structural rigidity is not of primary concern, aeration of the polymeric carrier material may ultimately yield an encapsulating compound having a lowest dielectric constant. Aeration may also be accomplished by employing a filler material comprising hollow spheres, rods, etc., of low dielectric constant material which, when at least partially filled with air, results in an encapsulating compound having a lower dielectric constant compared to using a filler material comprised of solid spheres, rods, etc.

By way of example only, Table 1 below lists several low dielectric constant (e.g., less than about 3.0) materials suitable for use as the filler material in the encapsulating compound, either alone or in combination with one or more other dielectric materials.

TABLE 1

| | Dielectric Constant |
|---|---|
| Material | (Low Freq.) |
| PTFE, molded | 2.1 |
| Polyperfluoroalkoxyethylene, molded/extruded | 2.1 |
| Fluorinated ethylene propylene (FEP), | 2.01-2.1 |
| molded/extruded | |
| ECTFE fluoropolmer | 2.47-2.5 |
| Nylon 6, unreinforced | 2.5 |
| Nylon 6, impact grade | 2 |
| Nylon 66, unreinforced | 1.9 |
| Polymethylpentene, molded | 2.1 |
| Polyphenylene ether, molded | 2 |
| Elf Atochem Orgalloy ® | 2.5 |
| DuPont 340 PFA copolymer | 2.1 |
| DuPont 100 FEP | 2.04 |
| Solvay Solexis HALAR ® 500 | 2.47 |
| Solvay Solexis Hyflon ® PFA 420 | 2.1 |

As previously stated, essentially any filler material having a dielectric constant that is less than the dielectric constant of the carrier material may be used to form the encapsulating compound, in accordance with the techniques of the present invention.

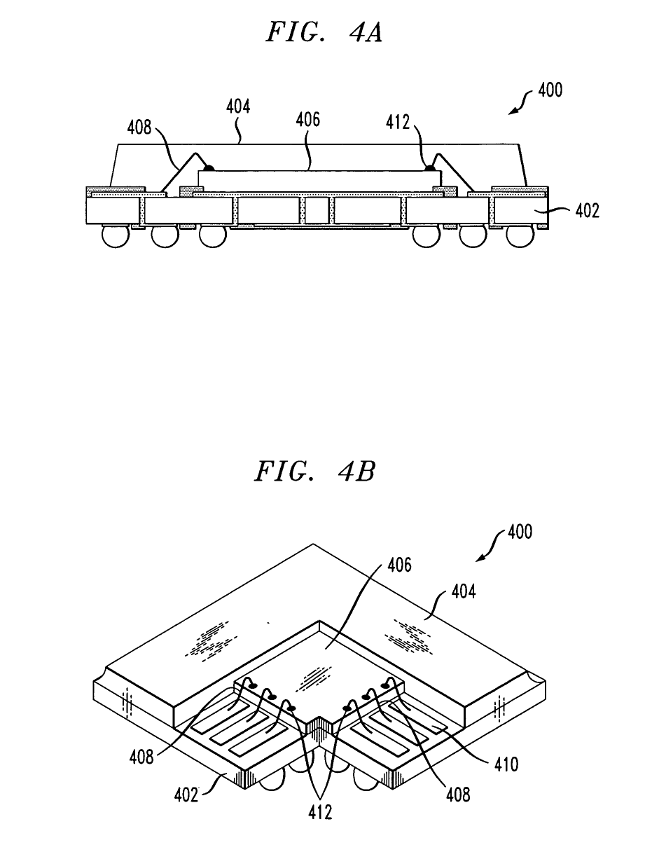

FIGS. 4A and 4B depict an exemplary packaged IC device 400 employing the encapsulating compound of the present invention. The packaged IC device shown in the figures illustrates just one application in which the techniques of the invention may be beneficially utilized. The device 400 preferably comprises an organic package board 402, or alternative substrate, for supporting an IC 406 mounted thereon. The package board 402 preferably includes a plurality of conductive leads 410, typically formed of copper, which provide electrical connection external to the device 400. Wire bonds 408 are included for providing electrical connection between the conductive leads 410 and corresponding bond pads 412 on the IC 406. The IC 406, bond wires 408, and at least a portion of the package board 402, are preferably encapsulated by an encapsulating compound 404, as shown.

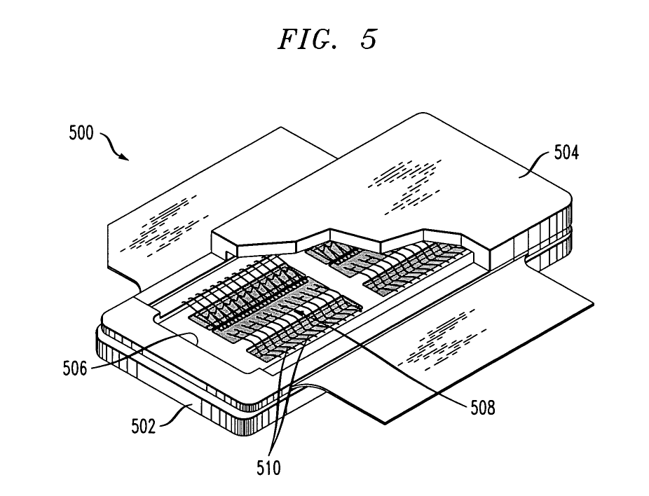

FIG. 5 is an isometric partial cut-away view depicting an open-cavity integrated circuit package 500 in which the techniques of the present invention may be employed. The package 500 includes a base 502 having an open cavity 506 formed therein for receiving an integrated circuit die 508. The base preferably comprises plastic, or an alternative material as will be known to those skilled in the art. After die attach and wirebonding processes, the die 508 and bond wires 510 are encapsulated using a reduced dielectric constant encapsulating compound of the type previously described herein in conjunction with FIGS. 1-3. A lid 504 is then attached to the base 502 in a conventional manner so as to protect the encapsulated cavity from environmental contaminants, etc.

The techniques of the present invention may be advantageously used to form an encapsulating compound having a reduced dielectric constant compared to traditional encapsulating compounds. To accomplish this, a dielectric filler material is added to an organic polymeric carrier material, a dielectric constant of the filler material being lower relative to a dielectric constant of the carrier material. The dielectric constant of the resulting encapsulating compound may be selectively controlled as a function of, among other parameters, the type of filler material and carrier material used, the shape and/or size of particles in the filler material, as well as the weight ratio of the filler material to the carrier material.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

1. An encapsulating compound, comprising:
an organic polymeric carrier material; and
a dielectric filler material, the dielectric filler material having a dielectric constant associated therewith which is less than a dielectric constant of the polymeric carrier material;
wherein the dielectric filler material is interspersed with the polymeric carrier material such that a dielectric constant of the encapsulating compound is less than the dielectric constant of the polymeric carrier material alone; and
wherein the dielectric constant of the encapsulating compound is controlled by selecting at least one of a weight percentage of the dielectric filler material and a particle size of the dielectric filler material, so as to achieve a particular value of the dielectric constant of the encapsulating compound.

2. (canceled)

3. The encapsulating compound of claim 1, wherein as the weight percentage of the dielectric filler material in the polymeric carrier material is increased, the dielectric constant of the encapsulating compound decreases.

4. The encapsulating compound of claim 1, wherein the weight percentage of the dielectric filler material in the polymeric carrier material is in a range from about one percent to about 95 percent.

5. The encapsulating compound of claim 1, wherein the dielectric filler material comprises at least one of polytetrafluoroethylene, ethylene tetrafluoroethylene, ethylene chlorotrifluoroethylene, perfluoroalkoxy, nylon, nylon 6, nylon 66, polymer, thermoplastic and fluoropolymer.

6. The encapsulating compound of claim 1, wherein the polymeric carrier material comprises one or more of a silicone gel, an epoxy and a molding compound.

7. (canceled)

8. The encapsulating compound of claim 1, wherein the polymeric carrier material comprises silicone gel and the dielectric filler material comprises polytetrafluoroethylene spheres, the weight percentage of the polytetrafluoroethylene spheres in the silicone gel being about eighty percent.

9. The encapsulating compound of claim 1, wherein the dielectric filler material comprises a plurality of different sized particles.

10. The encapsulating compound of claim 9, wherein the dielectric constant of the encapsulating compound is at least partially controlled by varying respective sizes of the particles in the dielectric filler material.

11. The encapsulating compound of claim 1, wherein the dielectric filler material comprises a plurality of different types of dielectric materials.

12. The encapsulating compound of claim 11, wherein the dielectric filler material comprises a plurality of different sized particles, each of the different sized particles corresponding to one of the different types of dielectric materials.

13. The encapsulating compound of claim 1, wherein the dielectric filler material is comprised substantially entirely of air, the dielectric filler material being added to the polymeric carrier material by aerating the polymeric carrier material to form air bubbles interspersed throughout the polymeric carrier material.

14. The encapsulating compound of claim 13, wherein a dielectric constant of the encapsulating compound is at least partially controlled by varying a size of the air bubbles in the polymeric carrier material.

15. The encapsulating compound of claim 1, wherein the dielectric filler material is substantially uniformly interspersed with the polymeric carrier material such that the dielectric constant of the encapsulating compound is substantially uniform throughout the encapsulating compound.

16. The encapsulating compound of claim 1, wherein the dielectric filler material is selectively interspersed with the polymeric carrier material so as to vary the dielectric constant of the encapsulating compound as desired throughout the encapsulating compound.

17-24. (canceled)

25. An integrated circuit device, comprising:
a package substrate;
an integrated circuit fixedly attached to the package substrate; and
an encapsulating compound formed on the integrated circuit and at least a portion of the package substrate, the encapsulating compound comprising an organic polymeric carrier material and a dielectric filler material, the dielectric filler material having a dielectric constant associated therewith which is less than a dielectric constant of the polymeric carrier material, the dielectric filler material being interspersed with the polymeric carrier material such that a dielectric constant of the encapsulating compound is less than the dielectric constant of the polymeric carrier material alone;
wherein the dielectric constant of the encapsulating compound is controlled by selecting at least one of a weight percentage of the dielectric filler material and a particle size of the dielectric filler material, so as to achieve a particular value of the dielectric constant of the encapsulating compound.

26. An encapsulating compound, comprising:
an organic polymeric carrier material; and
a dielectric filler material, the dielectric filler material having a dielectric constant associated therewith which is less than a dielectric constant of the polymeric carrier material;
wherein the dielectric filler material is interspersed with the polymeric carrier material such that a dielectric constant of the encapsulating compound is less than the dielectric constant of the polymeric carrier material alone; and
wherein the dielectric filler material comprises a plurality of different sized particles, the dielectric constant of the encapsulating compound being at least partially controlled by selecting respective sizes of the particles in the dielectric filler material, so as to achieve a particular value of the dielectric constant of the encapsulating compound.
